(19) United States
(12) Patent Application Publication
(10) Pub. No.: US 2008/0082952 A1
(43) Pub. Date: Apr. 3, 2008

(54) Method of inclusion of sub-resolution assist feature(s)

(75) Inventor: Sean C. O'Brien, Dallas, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 11/540,214

(22) Filed: Sep. 29, 2006

(51) Int. Cl. G06F 17/50

(52) U.S. Cl. 716/19

(57) ABSTRACT

A method of operating a computing system to determine reticle data. The reticle data is for completing a reticle for use in projecting an image to a semiconductor wafer. The method comprises receiving circuit design layer data comprising a desired circuit layer layout, the layout comprising a plurality of circuit features. The method further comprises providing the reticle data for inclusion in an output data file for use in forming reticle features on the reticle. This providing step comprises a first iteration and a second iteration. In a first iteration, the method indicates parameters for forming a plurality of primary features and a first plurality of assist features on the reticle and it selectively removes the parameters of selected ones of the first plurality assist features. In a second iteration, the method indicates parameters for forming a second plurality of assist features on the reticle.

### CROSS-REFERENCES TO RELATED APPLICATIONS

Not Applicable.

### STATEMENT REGARDING FEDERALLY SPONSORED RESEARCH OR DEVELOPMENT

Not Applicable.

### BACKGROUND OF THE INVENTION

The present embodiments relate to forming semiconductor circuit wafers and are more particularly directed to locating assist features, also referred to as sub-resolution assist features, on a mask (or reticle) for use with such wafers.

The history and prevalence of semiconductor devices are well known and have drastically impacted numerous electronic devices. As a result and for the foreseeable future, successful designers constantly are improving the semiconductor fabrication process, and improvements are in numerous areas including device size, fabrication efficiency, and device yield. The present embodiments advance these and other goals by improving the methodology for developing parameters to implement sub-resolution assist features on the masks used to form semiconductor devices.

By way of background and as known in the art, semiconductor devices are sometimes referred to as chips, and each chip is created from a portion of a semiconductor wafer. Typically, each chip is located in a respective area on the wafer referred to as a field. Various fabrication steps are taken to form electric circuits on each field. Some of these steps involve photolithography, whereby a light source is directed toward a mask, and light passes through only portions of the mask because so-called features have been previously formed on the mask so that the light that passes is determined by the location of the features. In other words, an image is projected through the mask based on the location of the features, where in some cases the feature is what blocks the light or in other cases the feature is what passes the light. In either case, typically the light image is further directed to a reduction lens that reduces the size of the image and the reduced image is then projected to a selected field on the wafer, where the field selection is determined by a device known as a stepper. The stepper gets its name because it causes the image to step through different fields on the wafer, that is, once the image is projected to one field on the wafer, the stepper disables the light source, re-positions either the mask or the wafer, and then enables the light source so that the same image from the same mask is then directed to a different field on the wafer, and so on for numerous fields. Thus, this process repeats until numerous images of the same type are directed to numerous respective fields on the wafer, with the stepper thereby stepping the image from one field to another on the wafer. As each image reaches a field on the wafer, typically the light reacts with a layer of photoresist that was previously deposited on the wafer. The resulting reacted photoresist layer is then etched to remove the unreacted photoresist, leaving behind structures on the wafer that correspond to the same size and shape as the reduced light that previously was directed through the mask and reducer to the wafer. These remaining wafer structures are also referred to as features and note, therefore, that each feature on the mask causes a corresponding feature on the wafer. However, each feature on the mask is larger in size, typically by some integer multiple (e.g., 2, 4, 5, 10), where the specific multiplier is implemented with respect to the wafer by the reducer lens. For example, in a case where the mask features are four times that desired on the wafer, the reducer lens reduces the size of the light image passing through the mask by a factor of four so that each resulting wafer feature will be one-fourth the size (in all dimensions) of each respective mask feature. In this manner, therefore, limitations on the mask may be at a larger size scale than on the wafer, due to the use of the reducer lens.

Given the use of imaging and masks as discussed above, various aspects of semiconductor design are necessarily limited by constraints of the mask and its related technology. In other words, since the mask defines the image that passes through it and that ultimately dictates the layout of the circuit on the wafer, then limitations of the mask represent limitations of the resultant wafer circuit. For example, it is well known that features on the mask may be made only down to a certain limited width, which as of this writing are typically on the order of 250 nm (nanometers). Moreover, in developing the location of features on a mask, various designers have developed methodologies that place limits on how closely two neighboring wafer features may be formed. More specifically, it has been determined that if such neighboring wafer features are too closely formed, then the wafer features cannot be resolved optically with conventional light source and mask techniques, causing an undesirable or unacceptable image on the wafer. Such limitations are particularly evident when a desired dimension of a wafer feature is smaller than the wavelength of the light that passes through the mask. In this regard, more recently technology has advanced with the use of two techniques that permit creation of even smaller wafer features, each of which is described below.

One technology used for improving wafer features in smaller circuits is known as a phase-shifting mask. In such a mask, the mask blocks light in certain areas and phase shifts light in other nearby areas typically so that the light passing through these latter areas is 180 degrees out of phase with respect to the areas that pass non-phase shifted light. As a result, in use of the mask there is overlap between the non-phase shifted and phase shifted light, causing light interference that effectively cancels some of the overlapping light and produces a clearer edge for the resulting wafer feature.

Another mask technology used for improving wafer features in smaller circuits is known by various names, such as feature assist, assist features, or sub-resolution assist features, where the last connotes that the assisting feature on the mask contributes to a corresponding wafer feature with greater resolution and printing margin than that otherwise obtainable for a given light wavelength. In any event, those assist features are features that are located on a mask, but a key goal of these features is that there is not a counterpart of the mask assist feature formed on the wafer. More particularly, ideally the mask assist feature is small enough and properly located on the mask so that that the assist feature is not transferred onto the wafer because the wafer features are below the dimensional resolution of the lithography system. However, the assist feature is also large enough so that that it does affect the passage of light and thereby impacts a nearby wafer feature, sometimes referred to in this context as a primary feature and that is formed therefore in response to a primary (non-assist) feature on the mask but is further defined by the light that is manipulated by the assist feature.

In view of the above, with assist (or assist feature) technology comes the complexity of a methodology for locating the assist features on the mask or reticle. Often such a method implements a rule-based computer program that considers various of the circuit attributes and layout dimensions so as to generate parameters that in turn are used to form both primary and assist features on the mask. The present embodiments, however, seek to improve upon such technology by permitting and forming additional assist features beyond those that are placed on a mask in the prior art, with the ability therefore to enhance the printability of corresponding primary features on the wafer, thereby reducing chip size, permitting greater device density per field, and improving yield for smaller dimension circuits. Various other benefits also may be ascertained by one skilled in the art, based on the remaining discussion set forth below. Thus, the prior art provides drawbacks in its limitations of achieving only certain primary feature definition and minimal wafer feature sizes, while the preferred embodiments improve upon these limitations as demonstrated below.

### BRIEF SUMMARY OF THE INVENTION

In the preferred embodiment, there is a method of operating a computing system to determine reticle data. The reticle data is for completing a reticle for use in projecting an image to a semiconductor wafer. The method comprises receiving circuit design layer data comprising a desired circuit layer layout, the layout comprising a plurality of circuit features. The method further comprises providing the reticle data for inclusion in an output data file for use in forming reticle features on the reticle. This providing step comprises a first iteration and a second iteration. In a first iteration, the method: (i) indicates parameters for forming a plurality of primary features on the reticle, where the primary features of the plurality of primary features corresponding to the plurality of circuit features; (ii) indicates parameters for forming a first plurality of assist features on the reticle, wherein in use of the reticle for use in projecting the image to the semiconductor wafer the first plurality of assist features, if formed on the reticle, are for assisting corresponding ones of the primary features; and (iii) selectively removes the parameters of selected ones of the assist features in the first plurality of assist features so that removed parameters are not used in forming reticle features. In a second iteration, the method indicates parameters for forming a second plurality of assist features on the reticle, wherein in use of the reticle for use in projecting the image to the semiconductor wafer the second plurality of assist features, if formed on the reticle, are for assisting corresponding ones of the primary features.

Other aspects are also disclosed and claimed.

### BRIEF DESCRIPTION OF THE SEVERAL VIEWS OF THE DRAWING

FIG. 1 illustrates a block diagram of a system for forming a reticle in accordance with the preferred embodiments.

FIG. 2a illustrates a block diagram of a portion of the surface of the reticle from FIG. 1 and per the prior art with a reticle assist feature symmetrically centered between two sufficiently-spaced primary features.

FIG. 2b illustrates a block diagram of a portion of the surface of the reticle from FIG. 1 and per the prior art with two reticle assists features symmetrically centered between two sufficiently-spaced primary features.

FIG. 2c illustrates a block diagram of a portion of the surface of the reticle from FIG. 1 and per the prior art with three reticle assists features symmetrically centered between two sufficiently-spaced primary features.

FIG. 3 illustrates a flowchart of a methodology to be implemented in format rules and methodology file 34₂ of FIG. 1 and per the preferred embodiments.

FIG. 4a illustrates a block diagram of a region that will result from data designating a primary feature to be constructed on a reticle per the job deck output data file 34₃ of FIG. 1.

FIG. 4b illustrates the region of FIG. 4a with an area extended away from the primary feature for purposes of examining whether data indicates an assist feature to be included in the area.

FIG. 4c illustrates the region of FIG. 4b after data has been added to designate an assist feature to be added within at least part of the extended area.

FIG. 5a illustrates a block diagram of a region that will result from data designating two primary features to be constructed on a reticle per the job deck output data file 34₃ of FIG. 1.

FIG. 5b illustrates the region of FIG. 5a with respective areas extended in a same dimension but in opposing directions and away from the respective primary features for purposes of examining whether data indicates an assist feature to be included in the areas.

FIG. 5c illustrates the region of FIG. 5b after data has been added to designate an assist feature to be added within at least part of the extended areas.

FIG. 6a illustrates a block diagram of a region that will result from data designating two primary features to be constructed per the job deck output data file 34₃ of FIG. 1 and with respective areas extended in different perpendicular dimensions and away from the respective data reticle primary features for purposes of examining whether data indicates an assist feature to be included in the areas.

FIG. 6b illustrates the region of FIG. 6a after data has been added to designate an assist feature to be added within at least part of the extended areas.

FIG. 7 illustrates a block diagram of a region that will result from data designating five primary features to be constructed per the job deck output data file 34₃ of FIG. 1, with respective areas extended away from the respective primary features, and after data has been added to designate an assist feature to be added with at least part of each of the extended areas.

### DETAILED DESCRIPTION OF THE INVENTION

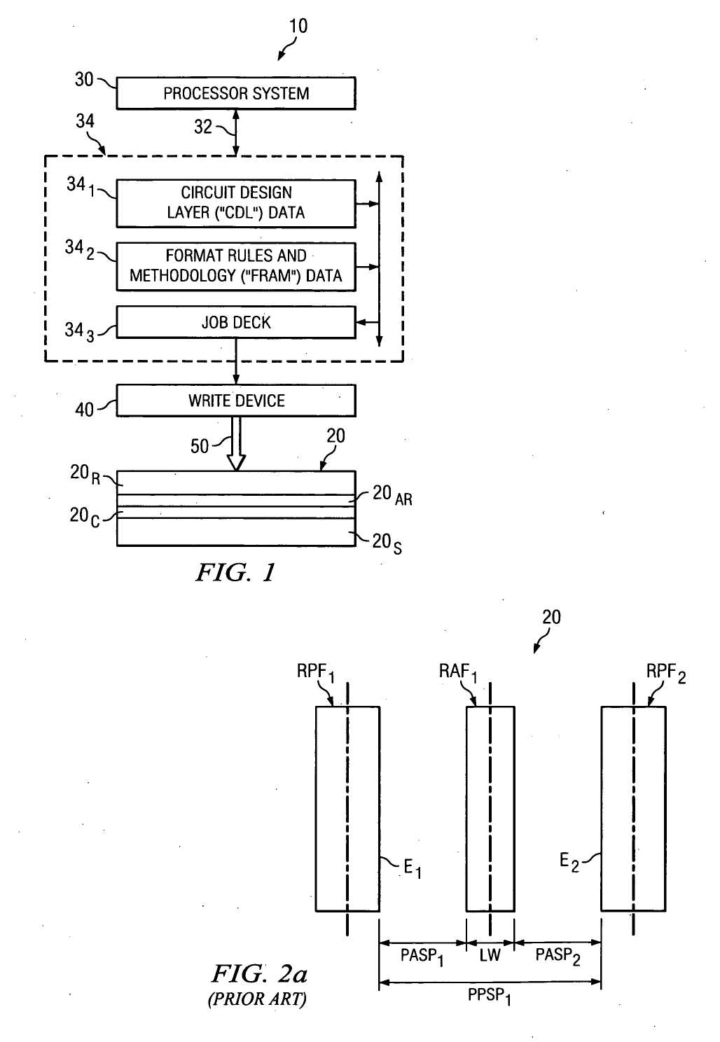

FIG. 1 illustrates a block diagram of a system 10 for forming a reticle 20 in accordance with the preferred embodiments. By way of introduction, the general nature of system 10 is known in the art, but novel aspects are added thereto and improve reticle 20 for reasons appreciated throughout the remainder of this document.

Looking then to system 10 in general, it includes a processor system 30 that may be embodied in various different forms of hardware and software, typically including one or more processors and/or computing devices. Processor system 30 has one or more interfaces 32 coupled to a data store 34, where data store 34 represents any of various forms of storage such as drives and memory, and where such storage may retain program or other data that may be read/written with respect to processor system 30. Data store 34 is shown to provide two input data files 34₁ and 34₂ via interface 32 to processor system 30, and to receive an output data file 34₃ from processor system 30, and each of these files is discussed below. Lastly, note that system 30 may include numerous other aspects such as are common with various computing configurations, including other input devices (e.g., keyboards, mouse, touch pad, tablet, and the like), output devices (e.g., display, monitor, and the like), as well as other media, components, devices, and peripherals, although such aspects are neither shown nor described so as to simplify the present discussion.

The first input data file 34₁ from data store 34 to processor system 30 is designated circuit design layer (“CDL”) data 34₁. CDL data 34₁ is a digitization of a desired circuit layer layout features, thereby illustrating a desired corresponding image to be formed on reticle 20 so that a circuit layer may be formed later on a wafer and with features in the same shape and with scaled dimensions of the image. CDL data 34₁ is often created by one or more circuit designers, and indeed in some instances one company provides data 34₁ to another company for creation of reticle 20 to correspond to data 34₁. The circuit layer layout data of CDL data 34₁ typically has many shapes extending in various directions and these shapes are often referred to as features. Moreover, the layout pertains to materials and layers used in semiconductor fabrication processes. For example, typical types of layers used in the process include gate layer, contact layer, and via layer, where each of these is mentioned here as introduction to one preferred embodiment aspect discussed later. In any event, therefore, CDL data 34₁ provides the layout shape and dimensions of each item, or feature, that is desired to be ultimately formed on a wafer or to establish circuit devices, or parts thereof, on the wafer. For example, for the gate layer, CDL data 34₁ may indicate locations, layout, shape, and dimensions of polysilicon to be formed on a wafer. Thus, in the example of polysilicon, and with the many transistors typically formed in a circuit design, the polysilicon layer may have numerous locations indicated as included for forming respective transistor gates throughout the layout. However, polysilicon elsewhere in the layout may have other uses, such as in resistors, capacitors, interconnect, or plasma etch load features. Thus, these other uses also may be described by information included in CDL data 34₁. One skilled in the art will appreciate numerous other examples of types of structures and layers that may be indicated in CDL data 34₁.

The second input data file 34₂ from data store 34 to processor system 30 is designated format rules and methodology (“FRAM”) data 34₂ and in certain respects performs as known in the art. Specifically, FRAM data 34₂ includes programming information, rules, and parameters that may take various forms ascertainable by one skilled in the art, such as computer (or processor) instructions/programming and appropriate other data. FRAM data 34₂, with the operation of processor system 30, formats CDL data 34₁ into job deck output data file 34₃, which sometimes may be referred to other than as a job deck, where output data file 34₃ is later used to control a lithographic write by a write device 40; thus, write device 40 later and ultimately forms an image on reticle 20 and that corresponds to the layout described by CDL data 34₁. Looking then to FRAM data 34₂ in a little more detail, it is used by processor system 30 to convert the data from CDL data 34₁ into a language compatible with write device 40, where this conversion is sometimes referred to as fracturing. The conversion divides the layout into shapes (e.g., rectangles and trapezoids) that are usable by write device 40. FRAM data 34₂ also may make changes in size and rotation, add fiducials and internal references, and make other data alterations as known to one skilled in the art.

Continuing with FRAM data 34₂, it also includes additional novel aspects directed to the preferred embodiments. By way of introduction to these aspects, recall that the Background Of The Invention section of this document introduces sub-resolution assist features (hereafter referred to as “assist feature” or, plural, “assist features”). In this regard, FRAM data 34₂ also provides rules and a methodology, detailed later, for inclusion of assist features into job deck output data file 34₃. These assist features are features that are not provided with circuit feature counterparts in CDL data 34₁, but in response to FRAM data 34₂ are added to the job deck output data file 34₃ so that the assist features may be printed on reticle 20, for assistance and in addition to the primary features that are printed on reticle 20 due to corresponding layout information in CDL data 34₁. Further in this regard and again by way of introduction, the rules and methodology of FRAM data 34₂ preferably cause an iteration that provides an initial inclusion of assist features for placement into job deck output data file 34₃. However, in the preferred embodiment methodology, an additional iteration is provided and examines spatial locations, corresponding to regions on reticle 20, where assist features do not exist to a certain extent or for which assist features were designated for inclusion but were thereafter removed, and under a different set of criteria additional assist features may then be included in such locations. In any event, once job deck output data file 34₃ is complete and with all primary and assist features therein, it is used to form a reticle 20 that is later used to impinge an image on a semiconductor wafer; when reticle 20 is so used, the assist features on reticle 20 do not cause a corresponding image on the wafer but instead assist in forming and defining better resolution and dimensions in the wafer features that correspond to the primary features on reticle 20.

Completing some observations with respect to system 10, the job deck output data file 34₃ is provided to a write device 40. Write device 40 controls either an electron beam or laser beam 50 so that it traces a beam across the surface of reticle 20 based on the information in job deck output data file 34₃. Specifically, reticle 20 includes a substrate 20_{S}, over which is a chrome layer 20_{C}, over which is an anti-reflection layer 20_{AR}, over which is a resist layer 20_{R}. Write device 40 performs a lithographic process by controlling the beam so that it writes to resist layer 20_{R} an image, or “geometry,” that follows the data in file 34₃, which recall should define reticle primary features that approximate that of CDL data 34₁ as provided by FRAM data 34₂. As introduced above and detailed below, FRAM data 34₂ in this regard causes reticle assist features to be included in file 34₃ so that they will later be physically formed on reticle 20 to be positioned strategically with respect to many reticle primary features based on various considerations. In any event, the light in beam 50 reacts with resist layer 20_{R} in those areas where the write occurs. Thereafter, a developing process is performed so that any resist that has been so reacted, or “exposed,” will be removed, leaving openings down to chrome layer 20_{C}. Next, reticle 20 is etched, that is, the portions of anti-reflection layer 20_{AR} and chrome layer 20_{C} that are now exposed are removed. Finally, the unreacted portions of resist layer 20_{R} are removed, thereby leaving clear (or sometimes called “glass”) areas through which light may pass in the areas that were etched, while also leaving portions of anti-reflection layer 20R elsewhere. Accordingly, reticle 20 now may be used in connection with a stepper or the like so that light may be passed through the clear areas on reticle 20 toward a wafer (not shown), while the light is blocked by the portions where anti-reflection layer 20_{AR} remains, where such latter portions are often referred to as chrome, dark, or opaque. These remaining areas, therefore, include the reticle primary and assist features.

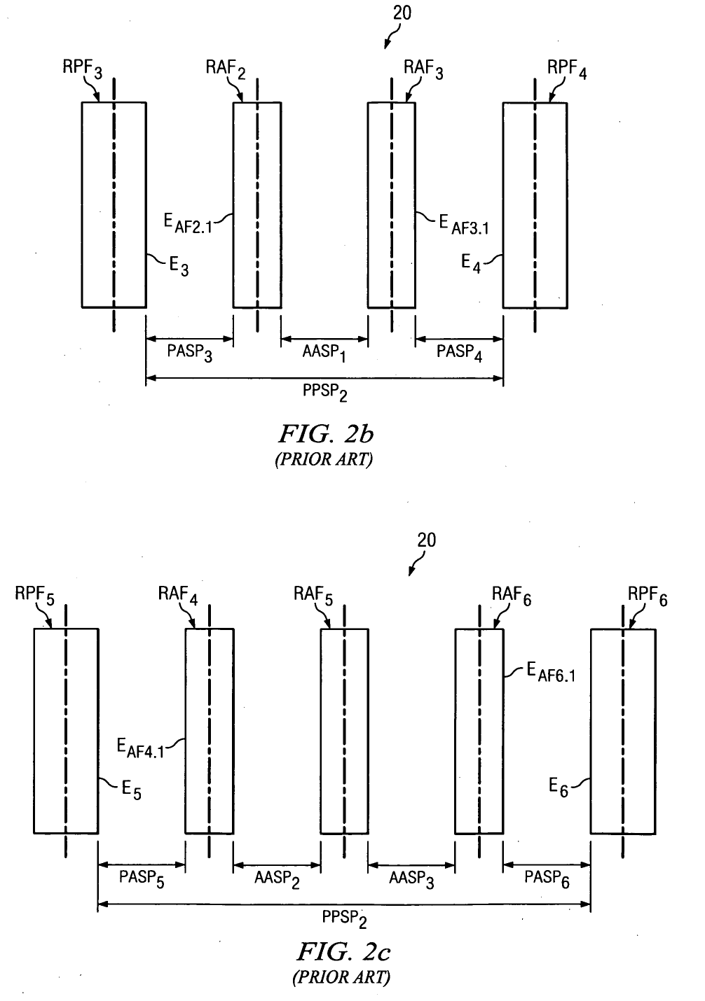

Before further detailing various preferred embodiment aspects, some background to certain prior art methodologies for locating reticle assist features with respect to reticle primary features is now provided, starting with FIG. 2a. FIG. 2a illustrates a block diagram of a portion of the surface of reticle 20 and that includes portions of chrome layer 20_{C} from FIG. 1, where those chrome portions define a few dark areas that have been formed and, thus, are shown in the perspective of FIG. 2a. As known in the art and in connection with a bright field reticle, the dark areas, such as in FIG. 2a, are referred to as features. Similarly, however, in an opposite approach, a dark field reticle may be formed wherein the open lines are the rectangles in FIG. 2a while the remainder of the reticle is darkened (i.e., covered with chrome), where in this case the open areas are referred to as features. In either event, and for sake of consistency and explanation in this document, each feature on the reticle is further identified herein as either: (i) a reticle primary feature where it is included so as to later cause the formation of a respective circuit feature (or “wafer feature” or “wafer primary feature”) on a wafer that is exposed to a light in combination with reticle 20; or (ii) a reticle assist feature, where the reticle assist feature is included proximate one or more reticle primary features and where the reticle assist feature is included so as to later influence the light diffraction and assist or contribute to the formation of the wafer circuit feature that is created due to the reticle primary feature that is proximate the reticle assist feature—further, when the reticle is so used, then ideally no wafer feature corresponding to the reticle assist feature should be printed on the wafer.

Looking specifically to the features in FIG. 2a, it illustrates a reticle primary feature RPF₁, a reticle primary feature RPF₂, and a reticle assist feature RAF₁. Each feature is shown to have a rectangular shape and for sake of reference has a respective major axis, shown by way of a respective dashed line—for purposes of this document, the major axis is an imaginary line that passes down the center of the longer dimension of the rectangular feature. Given the major axes, note that the axis of reticle primary feature RPF₁ is parallel to that of reticle primary feature RPF₂ and, thus, these two features are parallel to one another. For sake of distinction and not necessarily with an accurate scale, the line width LW (i.e., perpendicular to the major axis) for reticle assist feature RAF₁ is shown to be less than that of reticle primary features RPF₁ and RPF₂. Also, while the features are all shown to have the same length, such is not required but is provided for sake of simplifying the present discussion. Still further, a primary-to-primary feature space PPSP₁ is shown between the closest edges E₁ and E₂, respectively, of the two reticle primary features. With these introductions, and according to the prior art, where two reticle primary features are to be formed on a reticle such as shown in FIG. 2a, and provided the primary-to-primary feature space PPSP₁ between them is in a certain range (e.g., 330 to 430 nm), then a system such as system 10 also locates a reticle assist feature RAF₁ centered between the two reticle primary features RPF₁ and RPF₂. Thus, in FIG. 2a, the primary-to-assist space, shown as PASPₓ and defined as the distance from an edge of a reticle primary feature to the closest edge of an adjacent reticle assist feature, is the same with respect to both reticle primary features and reticle assist feature RAF₁. In other words, PASP₁ and PASP₂ are equal to one another, thereby centering reticle assist feature RAF₁ between reticle primary features RPF₁ and RPF₂.

Given the illustrations of FIG. 2a, various observations are now made with respect thereto and for relating later to the preferred embodiments. Reticle primary features are described herein as “primary-type adjacent” relative to one another in that each is a primary type (i.e., as opposed to assist type) and they are situated such that there is not another reticle primary feature between these two reticle primary features. Thus, where two reticle primary features are primary-type adjacent in this manner and where one such reticle primary feature has at least some respective portion that is parallel to the other reticle primary feature, and presuming the reticle primary features are within a certain distance of one another and at least a predetermined minimum distance apart, then the prior art locates an assist feature equidistantly between the two. As a result, when reticle 20 is used to later write an image to a wafer, a first wafer feature will be written to the wafer by light passing around reticle primary feature RPF₁, a second wafer feature will be written to the wafer by light passing around reticle primary feature RPF₂, and while no third wafer feature will be formed from reticle assist feature RAF₁, it will instead influence the light so as to provide better image quality and pattern to enable the printing of the wafer features corresponding to reticle primary features RPF₁ and RPF₂. In this manner, therefore, reticle assist feature RAF₁ is also sometimes referred to as “shared” with respect to the reticle primary features, in that the former contributes to the wafer features created by the latter.

FIG. 2b illustrates a block diagram of a different portion of the surface of reticle 20 in a manner comparable to FIG. 2a, but that includes different features so as to illustrate another prior art approach. Particularly, in FIG. 2b, there are shown a reticle primary feature RPF₃, a reticle primary feature RPF₄, and two reticle assist features RAF₂ and RAF₃, where all of these features are (or include portions that are) parallel with respect to one another. In FIG. 2b, it is assumed that the primary-to-primary feature space PPSP₂ between reticle primary features RPF₃ and RPF₄ is greater than that (i.e., PPSP₁) in FIG. 2a, and therefore again at least a predetermined minimum distance apart. As a result, and also according to the prior art, a larger number of reticle assist features are located between the reticle primary features. Thus, in the example of FIG. 2b, rather than including one reticle assist feature as was the case in FIG. 2a, then two reticle assist features RAF₂ and RAF₃ are formed on the reticle surface. Per the prior art, reticle assist features RAF₂ and RAF₃ are symmetrically located between reticle primary features RPF₃ and RPF₄ such that the primary-to-assist space PASP₃ between adjacent edges E₃ and E_{AF2.1}, respectively, of reticle primary feature RPF₃ and reticle assist feature RAF₂, and the primary-to-assist space PASP₄ between adjacent edges E₄ and E_{AF3.1}, respectively, of reticle primary feature RPF₄ and reticle assist feature RAF₃, are the same distance (i.e., PASP₃=PASP₄). The assist-to-assist space AASP₁ may vary, but note that regardless of its dimension there is still symmetry with respect to each reticle assist feature relative to its closest reticle primary feature. In this manner, when reticle 20 is used to write the image from FIG. 2b to a wafer, reticle assist feature RAF₂ influences the light that will form the wafer feature corresponding to reticle primary feature RPF₃ in the same way and to the same extent that reticle assist feature RAF₃ influences the light that will form the wafer feature corresponding to reticle primary feature RPF₄.

FIG. 2c illustrates a prior art block diagram of yet another different portion of the surface of reticle 20 in a manner comparable to FIGS. 2a and 2b, where the space between the reticle mask features is increased farther as compared to FIGS. 2a and 2b. As a result, in FIG. 2c, there are shown a reticle primary feature RPF₅, a reticle primary feature RPF₆, and three reticle assist features RAF₄, RAF₅, and RAF₆, where all of these features include portions that are parallel with respect to one another. Moreover and also according to the prior art, the number of reticle assist features is increased as compared to the earlier Figures. Further, reticle assist features RAF₄, RAF₅, and RAF₆ are symmetrically located between reticle primary features RPF₅ and RPF₆ such that the primary-to-assist space PASP₅ between adjacent edges E₅ and E_{AF4.1}, respectively, of reticle primary feature RPF₅ and reticle assist feature RAF₄, and the primary-to-assist space PASP₆ between adjacent edges E₆ and E_{AF6.1}, respectively, of reticle primary feature RPF₆ and reticle assist feature RAF₆, are the same distance (i.e., PASP₅=PASP₆). Moreover, reticle assist feature RAF₅ is centered as between reticle primary features RPF₅ and RPF₆ (i.e., AASP₂=AASP₃). In this manner, when reticle 20 is used to write the image from FIG. 2c to a wafer, reticle assist features RAF₄ and RAF₅ influence the light that will form the wafer feature corresponding to reticle primary feature RPF₅ in the same way that reticle assist features RAF₅ and RAF₆ influence the light that will form the wafer feature corresponding to reticle primary feature RPF₆.

Additional placements of reticle assist features may be performed in various manners. For example, other placements are known in the art and are not illustrated herein but a few additional aspects are worth mentioning. While FIGS. 2a through 2c show up to three reticle assist features, that number may be increased still further as between two primary-type adjacent reticle features that are at least a predetermined minimum distance apart. Thus, the number of reticle assist features may vary and the prior art locates them symmetrically between the primary-type adjacent reticle features. Note also that assist features also may be used with respect to a reticle primary feature that is sufficiently far away from any other primary feature so as to be considered isolated. In this “isolated” case, then reticle assist features are typically placed on both sides and at equidistant distances from the isolated reticle primary feature, again creating a symmetry, but here such that the reticle primary feature is centered with respect to the reticle assist features. Lastly, assist features may be located according to co-pending patent application Ser. No. 11/340,251, entitled “Method of Locating Sub-resolution Assist Feature(s)”, filed Jan. 25, 2006, and hereby incorporated herein by reference.

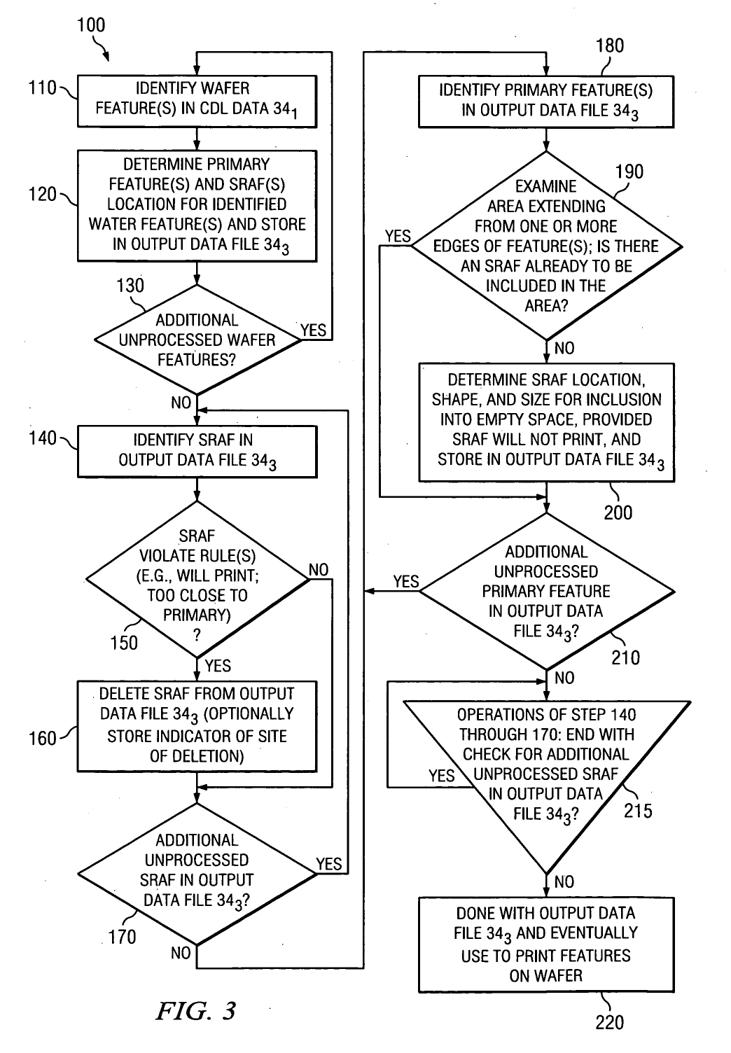

FIG. 3 illustrates a flowchart of a methodology 100 to be implemented by processor system 30 per FRAM data 34₂ of the preferred embodiment in FIG. 1 as well as its effect in creating job deck output data file 34₃. While methodology 100 is shown by way of a flowchart, one skilled in the art will appreciate that it may be implemented in various forms and included within system 30, such as by programming code, instructions, rules, parameters, and other data in FRAM data 34₂ and with the appropriate responses and operation by processor system 30. Moreover, various steps may be substituted or re-arranged in the flow or occur concurrently depending on processing power and the like, and the flow also may be illustrated in other forms such as a state machine or still others. In all events, the following steps and illustration therefore are by way of example and do not exhaustively limit the inventive scope.

By way of introduction, methodology 100 includes at its beginning a number of steps 110 through 170. These steps are explored below and are shown to in effect perform a first iteration of analyses on CDL data 34₁ so that data for primary features corresponding to circuit layout data in CDL data 34₁ are written to job deck output data file 34₃, and data for assist features are also included in output data file 34₃ so as to assist the primary features (i.e., when later forming wafer features with a reticle 20 that is constructed from output data file 34₃). By example, steps 110 through 170 in a preferred embodiment may include steps that are known in the prior art or, alternatively, by another example some of these steps may be modified by one skilled in the art according to various techniques but in all events to yield data, such as for inclusion in output data file 34₃, to establish primary and assist features to be formed on reticle 20. In any event, however, the steps following step 170 are per the preferred embodiment and, as demonstrated later, operate to provide an additional iteration that identifies any area adjacent a primary feature that is, after the preceding iteration, sufficiently empty of an assist feature; per the preferred embodiment, the methodology performs additional analyses so as to potentially indicate an assist feature to be included in the respective empty area. Each of these aspects is further explored below.

Method 100 begins with a step 110, where in response to FRAM data 34₂ processor system 30 identifies one or more wafer features in CDL data 34₁, that is, it identifies wafer features that are to be established to correspond to the circuit features specified in CDL data 34₁, such as per the prior art. For example, the particular wafer feature or features identified in a given operation of step 110 depends on whether the wafer feature is isolated or is nearby one or more other wafer features. In this regard, the determination of whether a given wafer feature is considered isolated or nearby one or more other features depends on distances that are evaluated from the given wafer feature. Thus, in present technology this distance may be in the approximate range of 1 to 500 nm so that if the given wafer feature has no other wafer feature within that range of it, then it is considered isolated and may be separately identified by step 110. Alternatively, if the given wafer feature has one or more other wafer features within that range of it, then those wafer features with such a distance may all be identified for a given occurrence of step 110. Next, method 100 continues from step 110 to step 120.

In step 120, and again in response to FRAM data 34₂, processor system 30 determines and stores into output data file 34₃ the size, shape, and location of one or more reticle primary (i.e., non-assist) features and one or more reticle assist features for the wafer feature(s) identified in step 110. Further, the determined feature information is preferably stored in job deck output data file 34₃ (or in memory for later writing to output data file 34₃). This determination again depends on whether the step 110 identified wafer feature is isolated or adjacent one or more other wafer features, as well as the methodology in FRAM data 34₂. For example, if a step 110 wafer feature is isolated, then step 120 preferably determines to locate a reticle primary feature of a particular size and shape, for ultimate printing on a reticle 20, so that the primary feature will cause the formation of the corresponding isolated wafer feature. In addition, however, and consistent with the discussion in the Background Of The Invention section, step 120 may determine and store the size, shape, and location of a reticle assist feature to assist the reticle primary feature in forming the corresponding isolated wafer feature, provided such a reticle assist feature will not cause a corresponding print on a wafer. As another example, if a step 110 identified wafer feature is within a predetermined distance of another step 110 identified wafer feature (i.e., if the wafer features are primary-type adjacent); then step 120 preferably determines and stores the size, shape, and location of two respective reticle primary features, for ultimate printing on a reticle 20, so that each reticle primary feature will cause the formation of a respective corresponding wafer feature. In addition, however, and consistent with the earlier discussion of FIG. 2a and thereafter, step 120 may determine and store data for the size, shape, and location of one or more reticle assist features to later assist the reticle primary features in forming the corresponding two wafer features. These reticle assist features may be located per the data, by ways of example, as shown in FIGS. 2a, 2b, and 2c, so as to be centered between the primary features and thereby to assist each primary feature equally. Alternatively, per the teachings of the above-incorporated U.S. patent application Ser. No. 11/340,251, the reticle assist features may be located per the data so as to assist in the formation of one step 110 identified reticle feature more than the other step 110 identified wafer feature. Still other techniques may be used to locate reticle primary and reticle assist features for step 110, as may be ascertained by one skilled in the art. Moreover, while a single step 110 is shown for the generation of reticle primary and reticle assist feature data, this step may be separated into separate processes as well so that reticle primary feature data are established in one instance and reticle assist feature data are established in another. Following step 120, method 100 continues to step 130.

Step 130 is a conditional step that determines whether there are additional wafer features in CDL data 34₁ that have not yet been processed per steps 110 and 120, that is, whether there are wafer features for which a reticle primary feature and consideration of assist have not yet been made. If one or more additional such wafer features exists, then method 100 returns from step 130 to step 110, so that the additional unprocessed wafer features are identified and data for at least a respective reticle primary feature, and possibly a reticle assist feature, is provided into output data file 34₃ for each wafer feature described by data in CDL data 34₁. Once each such wafer feature has been identified (and processed by step 120), the condition of step 130 is answered in the negative, and method 100 continues from step 130 to step 140.

Steps 140 through 170 operate to remove some of the reticle assist features that were previously included by step 120 for inclusion into job deck output data file 34₃. Specifically, the prior art recognizes that through the analyses conducted by the repeated iterations of step 120, certain reticle assist features that were planned for inclusion, or for which data was stored, in data file 34₃ may be undesirable for one of various reasons and, therefore, are candidates for removal from output data file 34₃. Toward this end, step 140 identifies the data for a reticle assist feature stored for inclusion or already in output data file 34₃, and method 100 then continues to step 150.

Step 150 determines whether the step 140 identified reticle assist feature data violates any rule in FRAM data 34₂ that may indicate that the reticle assist feature is undesirable for final use on reticle 20. In this regard, note that typically in contemporary applications of method 100 a very large number of assist features are initially indicated by the many occurrences of step 120 file of for a given CDL data 34₁. For example, for such a file, the repeated instances of step 120, corresponding to the many step 100 identified wafer features, may give rise to hundreds of millions of reticle assist features being indicated for inclusion into output data file 34₃. However, in the subsequent analysis of step 150, there is a chance for the data that provides for some of these reticle assist features to be removed from, or prevented from being written to, output data file 34₃. For example, step 150 may determine whether a step 140 identified reticle assist feature will, when used on reticle 20, cause a respective feature to print on a wafer; if this is the case, then the reticle assist feature is undesirable and step 150 is answered in the affirmative. As another example, step 150 may determine that a step 140 identified reticle assist feature would, if included on a reticle 20, be located too dose to a nearby reticle primary feature, thereby improperly assisting or wrongfully affecting the wafer feature to be formed in response to the nearby reticle primary feature; again, if this is the case, then the reticle assist feature is undesirable and step 150 is answered in the affirmative. As still another example, step 150 may determine that a step 140 identified reticle assist feature would, if included on a reticle 20, create a process violation. Still other examples may be ascertained by one skilled in the art. In any event, if step 150 is answered in the affirmative, method 100 continues to step 160. Alternatively, if step 150 is answered in the negative, method 100 continues to step 170.

Step 160 deletes from output data file 34₃, or prevents the writing into output data file 34₃, the data that specifies the reticle assist feature identified and analyzed in the immediately preceding occurrence of steps 140 and 150. Returning to the first example of the preceding paragraph, therefore, if a reticle assist feature is determined to present a risk of causing a corresponding print on a wafer, then step 160 ensures that the data that would create the reticle assist feature is not included in output data file 34₃. Alternatively looking to the second example of the preceding paragraph, if a reticle assist feature is determined to be planned for location that is too dose or inoperative relative to the location of a nearby reticle primary feature also specified in output data file 34₃, then step 160 ensures that the data that would create the reticle assist feature is not included in output data file 34₃. Further, and for reasons detailed later, in one preferred embodiment, step 160 may optionally store an indication of the location that the deleted reticle assist feature would have occupied had it been left in output file 34₃ for purposes of being printed on a reticle. Following step 160, method 100 continues to step 170.

Step 170 is a conditional step that determines whether there are data specifying additional reticle assist features in output data file 34₃ (or that are indicated, such as in memory, for inclusion into output data file 34₃) that have not yet been processed per steps 140 and 150, that is, whether there are reticle assist features that have not been reviewed by step 150. If one or more additional such assist features exists, then method 100 returns from step 170 to step 140, so that the additional unprocessed assist feature(s) may be identified and analyzed. Once each such reticle assist feature in output data file 34₃ has been identified by step 140 and processed by step 150, the condition of step 170 is answered in the negative and method 100 continues from step 170 to step 180.

Having reached step 180, an overview is now presented of the results of methodology 100 thus far as well as the remaining steps of methodology 100. From the preceding steps, one skilled in the art will appreciate that output data file 34₃ includes data specifying numerous reticle primary features as well as numerous reticle assist features. The reticle primary features were specified and included in output data file 34₃ from numerous iterations of step 120, and note that in a typical contemporary circuit there may at this point be in the range of 100 to 500 million reticle primary features. Further, recall that by way of example there could be hundreds of millions of reticle assist features from the numerous iterations of step 120, and note also that with numerous iterations of step 160 then on the order of 0.001%, which in the present example may be tens of thousands (or more), of those reticle assist features may be subsequently removed, or kept from, output data file 34₃. Thus, at this point in the process, one skilled in the art could proceed, and indeed in the prior art in many instances would proceed, to use output data file 34₃ to create reticle 20. However, in the preferred embodiments, starting with step 180 and thereafter, additional reticle assist features may be included in output data file 34₃ prior to creating a reticle 20 with that file, as further explored below.

In step 180 and in response to FRAM data 34₂, processor system 30 identifies the data specifying one or more reticle primary features in output data file 34₃, where the particular reticle primary feature or features in a given operation of step 180 depends on whether the reticle primary feature is isolated or is nearby one or more other reticle primary features. In this regard, the determination of whether a given reticle primary feature is considered isolated or nearby one or more other features depends on a distance that is evaluated from the given primary feature. Thus, in the preferred embodiment, a reticle primary feature is considered isolated if there is no other primary feature within a distance of 1 to 850 nm from the given reticle primary feature. Alternatively, step 180 will identify multiple reticle primary features if those features are all within the distance of 1 to 850 nm from one another. Next, method 100 continues from step 180 to step 190.

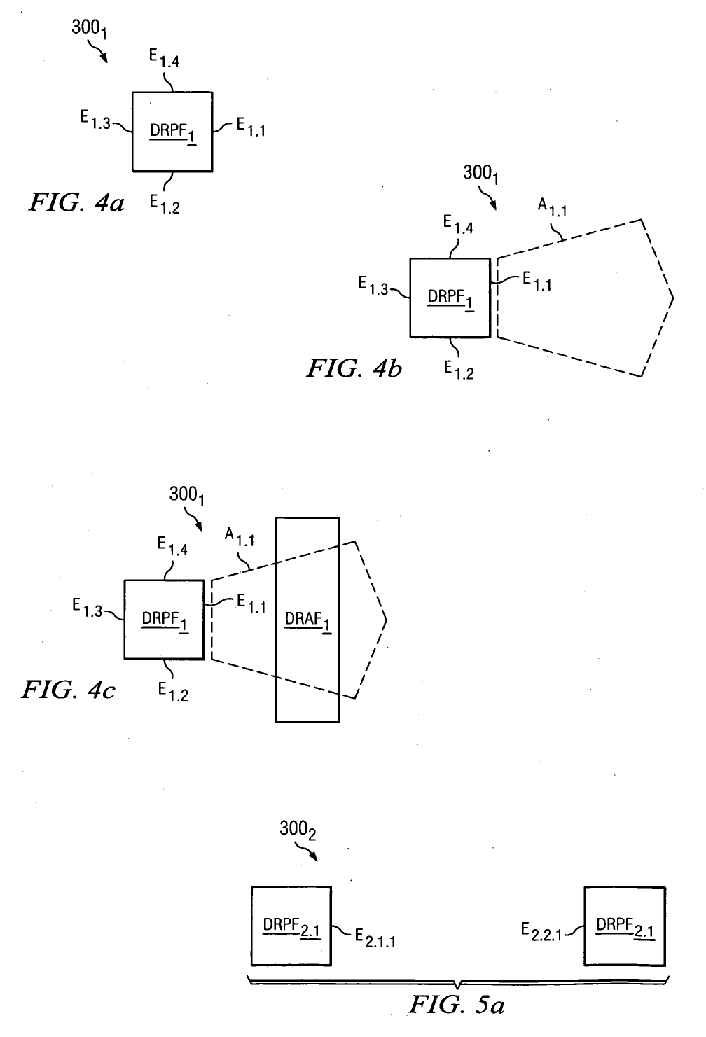

In step 190, processor system 30 examines an area adjacent to and extending away from an edge of the step 180 identified reticle primary feature(s) and then determines if a threshold-exceeding amount of a reticle assist feature already has been located (i.e., by specified data), at least in part, in that area according to the designations in output data file 34₃, for example where such a reticle assist feature was previously indicated to be located in that area into output data file 34₃ by step 120. To further illustrate step 190 in this regard, FIG. 4a illustrates a region 300₁ that is intended, in part, to be a pictorial representation of the data in output data file 34₃ insofar as it indicates reticle primary features and reticle assist features, that is, if the data calls for the formation of either type of feature then such a feature is shown in FIG. 4a. Thus, in FIG. 4a, a data reticle primary feature DRPF₁ is shown, where the descriptor “data reticle primary feature” is intended to suggest that data in output data file 34₃ indicates by data a reticle primary feature that thereafter will be printed on a reticle 20 if that printing is done per the data in output data file 34₃. However, region 300, is also intended to illustrate that output data file 34₃ does not, at the instant time of step 190, indicate that a reticle assist feature is to be formed in region 300₁ and, thus, only data reticle primary feature DRPF₁ is shown and there is no nearby assist feature. Continuing with the illustration of step 190 and looking now to FIG. 4b, it again illustrates region 300₁, but it further illustrates that step 190 examines an area shown in FIG. 4b by a dotted-lined enclosed area A_{1.1}; thus, in this preferred embodiment example, area A_{1.1} is defined by a polygon adjacent to and extending in a direction away from a respective edge E_{1.1} of data reticle primary feature DRPF₁. In the preferred embodiment, the polygon endosing area A_{1.1} is a pentagon, although other shapes may be used to define the area and the area may be symmetric or asymmetric. In any event, in the application of step 190 to data reticle primary feature DRPF₁, processor system 30 analyzes the data in output data file 34₃ to determine if there already is a reticle assist feature specified by data to be located at least in part within area A_{1.1}. More specifically, step 190 examines an area (e.g., area A_{1.1}) and determines whether the amount, if any, of a reticle assist feature in that area exceeds a threshold. This threshold may be selected by one skilled in the art and is preferably less than twenty and more preferably less than ten percent of the area; thus, in the latter example, step 190 determines whether any reticle assist feature area, within area A_{1.1}, is more or less than the threshold of the area A_{1.1}. So, for example, if area A_{1.1} is 43,000 nm², then step 190 determines if less than 4,300 nm² of that area includes a reticle assist feature. Note that the threshold may be reduced to any number. For example, by setting the threshold to zero percent, then step 190 determines if the examined area is devoid of or “empty” with respect to any part of a reticle assist feature. Alternatively, the threshold may be increased to somewhere between zero and ten percent to thereby determine if that area is devoid of or empty with respect to any non-negligible part of a reticle assist feature. Thus, for the remainder of this document, the examination of an area in this regard is referred to with respect to a threshold-amount of the area including any part of a reticle assist feature, where one skilled in the art should now understand that the threshold may be adjusted accordingly. Continuing then with step 190, if the examined area already includes a threshold-exceeding portion of a reticle assist feature, then step 190 is answered in the affirmative and method 100 continues to step 210, whereas if the examined area includes less than the threshold amount (e.g., does not include any portion) of an assist feature, then step 190 is answered in the negative and method 100 continues to step 200. Thus, in the example of FIG. 4b, no reticle assist feature is included within area A_{1.1} and, thus, method 100 continues to step 200. Note also in this regard, therefore, that step 190 permits a negative finding even if some below-the-threshold portion of the examined area includes a reticle assist feature, where again the determination of the threshold may be left to one skilled in the art and may be coded such that in some instances a relatively small amount of an existing reticle assist feature may be within the examined area and yet, because that amount is below the threshold, the area is deemed to be sufficiently “empty” with respect to a reticle assist feature and the method will therefore continue to step 200.

The above demonstrates that step 200 is reached when processor system 30 determines that an area adjacent a reticle primary feature edge is not indicated to include a threshold-exceeding amount of a reticle assist feature. In response, in step 200 processor system 30 includes into data output file 34₃ sufficient data so that a reticle assist feature will be formed in the area that was examined (e.g., area A_{1.1}) and found to be sufficiently lacking (i.e., less than the threshold) of a reticle assist feature, provided that when the features of the region (e.g., region 300₁) are later mapped to a corresponding reticle 20 the added reticle assist feature will not cause the printing of a respective feature on the wafer when the reticle 20 is used to process the wafer. In other words and in the example of FIG. 4b, in an area A_{1.1} adjacent to and extending away from a data reticle primary feature DRPF₁ and where no threshold-exceeding amount of a reticle assist feature was to exist after the preceding analyses and operations of step 120 (and possibly 160), then step 200 includes data so that a reticle assist feature will be included in that area. In this regard, FIG. 4c again illustrates region 300₁, but now it includes a data reticle assist feature DRAF₁; note also that the word “data” is included in this descriptor to indicate, similar to data reticle primary feature DRPF₁, that at this point the actual reticle primary feature or reticle assist feature is not yet created but the data describing it and from which it will be created is included in output data file 34₁. Thus, where the reticle primary feature identified in step 180 was previously unassisted by virtue of no (or relatively little) nearby reticle assist feature, then following step 200 that reticle primary feature will be assisted by a reticle assist feature, where by example in FIG. 4c data reticle primary feature DRPF₁ feature DRPF₁ will create a reticle primary feature and it will be assisted by a data reticle assist feature DRAF₁ created by step 200. In other words, where the first possible assist-inclusion iteration, step 120, that could have included an assist feature did not do so (or that assist feature was deleted by step 160), then step 200 provides an additional iteration that may indeed insert such an assist feature. Given that step 200 provides data for a reticle assist feature, in the preferred embodiment step 200 also provides the particular location, shape, and size for the reticle assist feature. In the preferred embodiment, the step 200 created reticle assist feature location may be at a set distance from the primary feature to be assisted, or as shown below by example centered between two primary features to be assisted, or determined by various methodologies detailed later. Also in the preferred embodiment, the step 200 reticle assist feature shape is preferably rectangular when it is to assist a single or isolated primary feature. Lastly, note also in the preferred embodiment that preferably the step 200 created reticle assist feature has dimensions equal to or less than any reticle assist feature defined in step 120, particularly because a larger assist feature may not have been included by step 120 (or was excluded by step 160) because such a larger size was unacceptable relative to the nearby reticle primary feature(s) that it would have assisted and, thus, a smaller step 200 data reticle assist feature is provided so as to reduce the chance of incurring the issue that the larger step 120 feature may have caused. Thus, the length of a step 200 reticle assist feature (e.g., shown in the vertical direction in FIG. 4c) may be in the range of 85 to 200 nm, whereas the length of a step 120 reticle assist feature may be in the range of 150 to 300 nm

Also in connection with steps 190 and 200, note that the illustration of FIGS. 4a through 4c is shown in connection with edge E_{1.1}, of data reticle primary feature DRPF_{1.1}. Only this single edge is discussed in order to simplify the demonstration. However, in the preferred embodiment, step 190 is performed, either in one instance or in repeated occurrences of the step, for each different linear edge of the step 180 identified data reticle primary feature. Thus, in the example of FIG. 4a, the same inquiry of step 190 is made for edges E_{1.1}, E_{1.3}, and E_{1.4}, where each of those edges therefore, if adjacent to an area (e.g., comparable to area A_{1.1} but extending away from the respective other edge) that does not include a threshold-exceeding part of a reticle assist feature, becomes a candidate for candidate for such an assist feature to be included by step 200, so long as that assist feature will not cause a respective wafer feature to be later printed. Thus, once all edges E_{x.y} of a data reticle primary feature have been analyzed by steps 190 and 200, then method 100 continues to step 210.

Step 210 is a conditional step that determines whether there are additional reticle primary features specified by data in output data file 34₃ (or that are indicated, such as in memory, for inclusion into data file 34₃) that have not yet been processed per steps 180, 190, and possibly 200, that is, whether there are data reticle primary features that have not been reviewed by step 190 to determine if an area adjacent an edge of such feature does not include at least a threshold-exceeding part of a reticle assist feature. If one or more additional such data reticle primary features exists, then method 100 returns from step 210 to step 180, so that such additional unprocessed primary feature(s) may be identified and analyzed. Once each such primary feature has been considered, the condition of step 210 is answered in the negative, and method 100 continues from step 210 to step 215.

Step 215 is intended to include the same operations as were performed in steps 140 through 170 discussed above, where these operations now follow a negative finding in step 210. Thus, when step 210 determines that there are not additional unprocessed primary features in output data file 34₃ to be processed by steps 180 through step 200, then step 215 represents that for those additional reticle assist features for which data were created by occurrences of step 200, then the operations of steps 140 through 170 are performed. Thus, for each such additional data reticle assist feature (i.e., step 140 type operation), an evaluation is made as to whether it violates any rule(s) (i.e., step 150 type operation) and, if so, that respective feature is deleted (i.e., step 160 type operation), continuing until all such additional data reticle assist features are considered (i.e., step 170 type operation). Thus, step 215 demonstrates that for step 200 added reticle assist features, these features are also each considered and deleted should any of them violate any step 150 rule. Step 215 ends with a condition like step 210 and is why a triangle is used for step 215 in the flowchart of FIG. 3, so that if there are any additional unprocessed data reticle assist features, the flow returns for each such feature and when all such features are processed, then preferably method 100 continues to step 220. However, note that in an alternative embodiment method 100 may return yet again to step 180 at this point. In this manner, therefore, after additional data reticle assist features have been included by step 200 and some of those have been deleted by the step 160 type operation of step 215, then in this alternative embodiment another occurrence(s) of step 180 could include yet additional data reticle assist features, and one skilled in the art may adjust the number of times that steps 180 through 200 are repeated in this manner.

Step 220 represents the completion of method 100, insofar as output data file 34₃ is complete and therefore ready for use to print the data reticle primary and data reticle assist features therein on a reticle 20. Thus, consistent with the earlier discussion of FIG. 1, at this point output data file 34₃ is used as a job deck to drive a write device 40, and write device 40 thereby writes to a reticle 20 the reticle primary and reticle assist features provided by the respective data in that job deck.

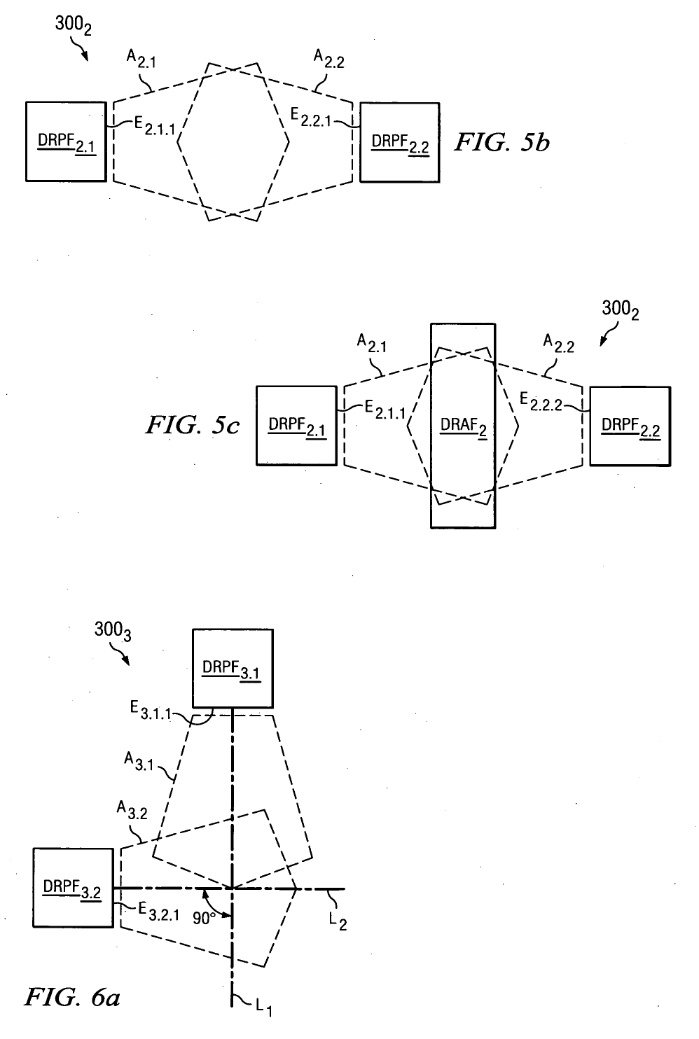

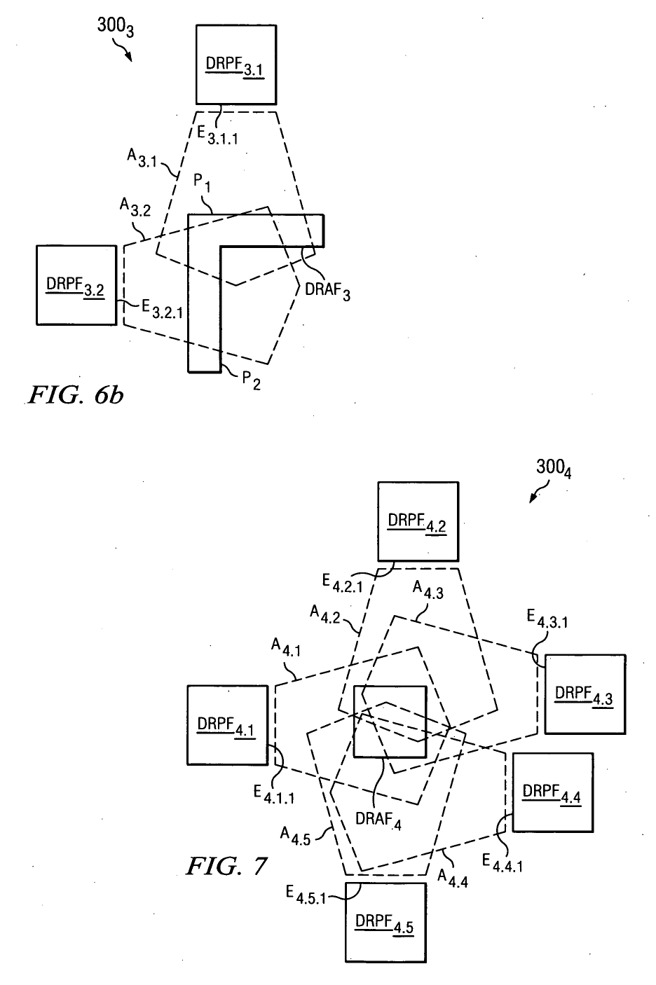

Having demonstrated via FIGS. 4a through 4c one example of the application of step 200 and the inclusion thereby of a data reticle assist feature into an area adjacent a data reticle primary feature that did not previously include at least a threshold-exceeding amount of a reticle assist feature, and recalling that in that example the data reticle primary feature was an isolated feature, additional Figures and discussion are now provided to demonstrate that step 180 may apply to other examples, including neighboring data reticle primary features. These examples are shown below in FIGS. 5a-5c, 6a-b, and 7.

FIG. 5a illustrates a region 300₂ that is intended to be a pictorial representation similar to FIG. 4a, meaning of the data in output data file 34₃ insofar as it indicates data reticle primary features and data reticle assist features (i.e., if the data calls for the formation of either type of feature then such a feature is shown in FIG. 5a). Also, FIG. 5a, like FIG. 4a above, is intended to demonstrate in part the operation of method 100 starting with step 180, that is, after the preliminary iterations through step 170 have been taken with respect to the data in CDL file 34₁, per the methodology in FRAM data 34₂, so as to provide data for reticle primary and reticle assist features to be formed on a reticle. In FIG. 5a, and per step 180, two data reticle primary features DRPF_{2.1} and DRPF_{2.2} are identified and thus shown in the Figure, meaning in this document that data in output data file 34₃ indicates that two respective data reticle primary features will be thereafter printed on a reticle 20 if constructed per output data file 34₃. Further, there is no reticle assist feature shown in region 300₂, thereby intending to depict that output data file 34₃ does not, as of the time of step 190, provide for a reticle assist feature to be formed in region 300₂; thus, were output data file 34₃ used at this point to construct features on a reticle, then with respect to region 300₂ only reticle primary features from data reticle primary features DRPF_{2.1} and DRPF_{2.2} would be constructed with no nearby reticle assist feature in region 300₂.

Turning to FIG. 5b, it again illustrates region 300₂, but it further illustrates that respective dotted-lined enclosed polygon areas A_{2.1} and A_{2.2} are examined by step 190. In the preferred embodiment, note therefore that when areas are extended from more than one data reticle primary feature such as in the example of FIG. 5b, then each such area is of a same geometry. Thus, in this example, area A_{2.1} is defined by a polygon extending away from a respective edge E_{2.1.1} of data reticle primary feature DRPF_{2.1} and in one dimension (shown horizontally) and area A_{2.2} is defined by a polygon of the same geometry and extending in the same dimension but in an opposite direction, namely, away from a respective edge E_{2.2.1} of data reticle primary feature DRPF_{2.2}. Thus, in the present example, step 180 identifies two data reticle primary features and the subsequent step 190 extends areas, preferably of the same geometry, from respective edges of the identified features. Moreover, in step 190, processor system 30 analyzes the data in output data file 34₃ to determine if there already is data specifying a data reticle assist feature to be located, at least spanning an area that exceeds the step 190 threshold, within either of areas A_{2.1} and A_{2.2}. In the example of FIG. 5b, it may be seen by the pictorial illustration of the data that no such reticle assist feature was previously indicated (e.g., by step 120) for those areas. Thus, method 100 continues to step 200, as further explored below in connection with FIG. 5c.

FIG. 5c illustrates region 300₂ following the application of FIG. 3 step 200 to FIG. 5b. For FIG. 5c, processor system 30 of FIG. 1 determines that an area adjacent a reticle primary feature edge is not indicated to include a threshold-exceeding amount of a reticle assist feature given that areas A_{2.1} and A_{2.2} are devoid of any part of a data reticle assist feature. In response, processor system 30 includes into data output file 34₃ sufficient data so that an assist feature will be formed when that file is used to process and thereby create features on a reticle. Also in the preferred embodiment, FIG. 5c illustrates an example of more than one identified data reticle primary feature, and in this case the step 200 added data reticle assist feature is located so that a least a portion of the added assist feature is within the respective area for each data reticle primary feature; thus, in the example of FIG. 5c, a data reticle assist feature DRAF₂ is added to the data in output data file 34₃ whereby at least a portion of data reticle assist feature DRAF₂ is within both areas A_{2.1} and A_{2.2} again provided that the added reticle assist feature will not cause the printing of a respective feature on a wafer when a respective reticle is used to process the wafer. Further, in the preferred embodiment and where two data reticle primary features have co-aligned areas extending toward one another as is the case in FIGS. 5b and 5c, and as occurs when an imaginary perpendicular line extended perpendicularly from one edge of one of those features would contact, in substantial perpendicular orientation, an edge of the other of those features (i.e., those features are “opposing” one another in orientation), then the added assist feature is preferably centered between the two data reticle primary features to be assisted. Thus, in the example of multiple data reticle primary features, and for their respective overlapping areas A_{2.1} and A_{2.2} where no reticle assist feature was to exist after the preceding analyses of step 120 (and possibly 160), then step 200 potentially includes data so that such an assist feature will be included and centered between the two primary features. Thus, where the data reticle primary features DRPF_{2.1} and DRPF_{2.2} identified in step 180 were previously unassisted by virtue of no nearby reticle assist feature, then following step 200 each such primary feature will be assisted by an assist feature DRAF_{2.2}.

With the illustrations of FIGS. 4a through 5c, one skilled in the art should readily appreciate that the preferred embodiment methodology examines an area adjacent a data reticle primary feature(s), and if that area does not encompass, at least a threshold-exceeding amount of a reticle assist feature to be included in that area, then data for a reticle assist feature may be added so that such a feature will be formed in that area. With that appreciation, FIG. 6a illustrates another example of the application of these aspects, and here in relation to a region 300₃. Specifically, to simplify the remaining discussion and illustrations, region 300₃ is shown pictorially as an example as it would appear from corresponding data after step 190 of method 100. Thus, looking to region 300₃, it includes two data reticle primary features DRPF_{3.1} and DRPF_{3.2}. Recall that FIG. 5a also illustrated two data reticle primary features, but in that case an imaginary perpendicular line extended from one edge of one of those features would contact, in perpendicular orientation, an edge of the other of those features (i.e., those features were “opposing” one another in orientation). In contrast, in FIG. 6a, the two data reticle primary features are oriented such that an imaginary perpendicular line L₁ extended from one edge (e.g., E_{3.1.1}) of one of those features (e.g., DRPF_{3.1}) is substantially perpendicular (i.e., 90 degrees or within a few degrees thereof) to an imaginary perpendicular line L₂ extending from one edge (e.g., E_{3.2.1}) of the other feature (e.g., DRPF_{3.2}), and the features are still sufficiently close to one another so that they are identified by step 180. In such an example, in applying step 190 to region 300₃, processor system 30 examines an area A_{3.1} extending away from edge E_{3.1.1} of feature DRPF_{3.1} and an area A_{3.2} extending away from edge E_{3.2.1} of feature DRPF_{3.2}. As in the case of FIG. 4b, in FIG. 6a the extended areas overlap and that overlapping area does not include, at least a threshold-exceeding amount of a reticle assist feature to be created as indicated by data presently in output data file 34₃, thereby giving rise by method 100 to a response as discussed below.

FIG. 6b illustrates region 300₃ following step 200 as applied to the same region of FIG. 6a. Thus, step 200 includes data into output data file 34₃ to provide for a data reticle assist feature DRAF₃, in at least the region of the overlapping areas A_{3.1.} and A_{3.2}. Recalling the perpendicular orientation of feature DRPF_{3.1} relative to feature DRPF_{3.2} (i.e., such that perpendicular lines L₁ and L₂ extending from the edges each perpendicularly cross one another), then preferably step 200 provides data specifying a reticle assist feature, shown in FIG. 6b as data reticle assist feature DRAF₃, that has two longer portions P₁ and P₂ (i.e., each with a length longer than its width), with one portion P₁ having a majority of its length parallel to the closest edge E_{3.1.1} of one primary feature DRPF_{3.1} and another portion P₂ having a majority of its length parallel to the closest edge E_{3.2.1} of the other primary feature DRPF_{3.2}. In this manner, when a reticle is formed using region 300₃, then portion P₁ will tend to assist data reticle primary feature DRPF_{3.1} and portion P₂ will tend to assist data reticle primary feature DRPF_{3.2}.

FIG. 7 pictorially illustrates data from a final example of the results from steps 180 through 200 of the preferred embodiments, where in this example more than two data reticle primary features are identified by step 180. In the example of FIG. 7, five such features are shown as DRPF_{4.1} through DRPF_{4.5}. To simplify this discussion and in view of the previous examples, FIG. 7 pictorially illustrates the result following the completion of step 200 with respect to region 300₄. In applying step 190 to region 300₄, processor system 30 examines areas A_{4.1.1} through A_{4.5.1} extending respectively from each edge E_{4.1.1} through E_{4.5.1} of each primary feature DRPF_{4.1} through DRPF_{4.5}. In the example of FIG. 7, the extended areas A_{4.x} are situated toward one another, although it should be understood that step 190 also may consider comparable areas in other directions. For instance, in FIG. 7, area A_{4.1} is considered and extends from edge E_{4.1.1}, although step 190 also may consider an area extending from any of the other edges of feature DRPF_{4.1}, as well as for the other features of FIG. 7. Returning to the example illustrated, the extended areas overlap and, while not shown as a separate figure, assume that each of the areas as of the time step 190 is applied do not include a threshold-exceeding amount of a reticle assist feature. In response, then step 200 includes data into output data file 34₃ to provide for a data reticle assist feature DRAF₄, in the region of the overlapping areas A_{4.1} through A_{4.5}. In the preferred embodiment, where the extending areas correspond to more than two data reticle primary features, then preferably step 200 provides a square-shaped assist feature, as shown in FIG. 7. In this manner, when a reticle is formed using region 300₄, then assist feature DRAF₄ will tend to assist each of data reticle primary features DRPF_{4.1} through DRPF_{4.3}.

Method 100 and the preceding examples thereby demonstrate various aspects of the preferred embodiment for determining size, shape, and location for reticle assist features through the additional steps 180 through 210. Further in this regard and as discussed partially above, the preferred embodiments may include various different methodologies for determining a specific location for such an assist feature. For example, in a case such as shown in FIG. 7 where more than two primary features are considered and have respective areas that do not include at least a threshold-exceeding amount of an already-determined assist feature, then such an assist feature is included so that it is at least partially within, or overlapped, by the overlapping portions of the examined areas. In such an instance, the preferred embodiment methodology for locating such an assist feature could be any of the following. In one approach, the preferred embodiment determines if there were two or more assist features in the examined area that were deleted by occurrences of step 160; if so, then in step 200, the location (e.g., x,y coordinate) of the step 200 added assist feature is based on the average of the locations (e.g., respective x,y coordinates) of the previously deleted assist features, where recall that step 160 may store an indication, including the intended location, of any step 160 deleted assist feature. In another approach, the preferred embodiment locates the step 200 assist feature according to a center-of-mass resulting from a sum of the individual examined areas (e.g., A_{4.1} through A_{4.5} in FIG. 7) corresponding to the primary features being considered, and this center of mass is a coordinate, such as the center coordinate, of the step 200 assist feature. In still another approach, each examined area (e.g., A_{4.1} through A_{4.5} in FIG. 7), corresponding to each considered primary feature, is assigned a specific x,y coordinate and the coordinates of the examined areas are averaged to arrive at the final x,y location of the step 200 assist feature. A final approach is to calculate a minimum sized geometry (e.g., rectangle or other shape) that completely contains the areas (e.g., A_{4.1} through A_{4.1} in FIG. 7) of all primary features being considered and using the center of that shape as the center of the step 200 assist feature. Lastly, while the preceding examples are preferable for instances where two or more primary features are being considered (e.g., FIG. 7), these or modifications thereof also may apply to the instance where only two primary features are being considered (e.g., FIGS. 5a-c, 6a-b).

From the above, it may be appreciated that the preferred embodiments provide a method for locating reticle assist features on a resulting reticle or mask for use in forming semiconductor circuits, where such features may be from either bright field or dark field reticles and such reticles may or may not use phase shifting and include other variants such as chromeless phase lithography. The method and resulting reticle herein described may have particular benefit in instances of complex semi-random circuit layouts. Thus, in a regular array of gates or contacts the need for the application of the preferred embodiments may be attenuated or bypassed, but in more random if not arbitrary layouts, the prior art may fail to locate reticle assist features or may have them deleted and in such case the preferred embodiments ultimately provide a greater amount of assist. In addition, the preferred embodiments improve upon the prior art, in that the prior art as well as step 110 through 170 herein may result in a small percentage of reticle sites with no discerned answer as to locating reticle assist features, whereas the preferred embodiments implement a secondary method to potentially place such assistance in those sites; this secondary method uses relaxed rules differing from those of the primary method and thereby increase the possibility of assistance in most sites. Further, various alternatives have been provided according to preferred embodiments, and still others may be ascertained by one skilled in the art. In all events, the preferred embodiments have been shown to provide one or more reticle assist features adjacent a reticle primary feature, where the reticle assist features may be established in a first iteration by a set of rules such as known in the art or other techniques, but in a second iteration a reticle assist feature may be added adjacent a reticle primary feature if there is an area extending from that primary feature that does not already include at least a threshold-exceeding amount of an assist feature. In this regard, therefore, in locations where no (or an insufficient amount of) reticle assist feature existed relative to a reticle primary feature in the prior art, the preferred embodiments provide the possibility of including such an assist feature, thereby further assisting with the creation of wafer features when the reticle assist feature is later used in connection with a reticle primary feature. Given the preceding, therefore, one skilled in the art should further appreciate that while the present embodiments have been described in detail, various substitutions, modifications or alterations could be made to the to the descriptions set forth above without departing from the inventive scope, as is defined by the following claims.

1. A method of operating a computing system to determine reticle data, the reticle data for completing a reticle for use in projecting an image to a semiconductor wafer, the method comprising:
receiving circuit design layer data comprising a desired circuit layer layout, the layout comprising a plurality of circuit features; and
providing the reticle data for inclusion in an output data file for use in forming reticle features on the reticle, the providing step comprising:
in a first iteration:
indicating parameters for forming a plurality of primary features on the reticle, the primary features of the plurality of primary features corresponding to the plurality of circuit features; and
indicating parameters for forming a first plurality of assist features on the reticle, wherein in use of the reticle for use in projecting the image to the semiconductor wafer the first plurality of assist features, if formed on the reticle, are for assisting corresponding ones of the primary features; and
selectively removing the parameters of selected ones of the assist features in the first plurality of assist features so that removed parameters are not used in forming reticle features; and
in a second iteration, indicating parameters for forming a second plurality of assist features on the reticle, wherein in use of the reticle for use in projecting the image to the semiconductor wafer the second plurality of assist features, if formed on the reticle, are for assisting corresponding ones of the primary features.

2. The method of claim 1 wherein the step of indicating parameters for forming a second plurality of assist features on the reticle comprises:
examining an area adjacent to and extending away from an edge of a primary feature in the plurality of primary features; and
including parameters for forming an assist feature at least in part in the area if less than a threshold amount of assist feature is to be formed in the area per the parameters for forming the first plurality of assist features.

3. The method of claim 2 wherein the area comprises a polygon area.

4. The method of claim 2 wherein the step of including parameters for forming an assist feature in the second plurality of assist features is conditioned on the assist feature in the second plurality of assist features not printing a corresponding feature on the semiconductor wafer when the reticle is used in projecting the image to the semiconductor wafer.

5. The method of claim 2 wherein the step of including parameters for forming an assist feature at least in part in the area comprises including parameters for forming a rectangular assist feature.

6. The method of claim 2:
wherein the step of examining an area adjacent to and extending away from an edge of a primary feature in the plurality of primary features comprises examining a respective area adjacent to and extending away from a respective edge of more than two primary features in the plurality of primary features; and
wherein the step of including parameters for forming an assist feature at least in part in the area comprises including a location for the assist feature at least in part in an overlap of the respective areas.

7. The method of claim 6 wherein the step of including a location for the assist feature comprises locating the assist feature at a location that is an average of respective locations of the selected ones of the assist features that prior to the step of selectively removing had locations in the examined respective areas.

8. The method of claim 6 wherein the step of including a location for the assist feature comprises locating the assist feature at a location that is a center-of-mass of the examined respective areas.

9. The method of claim 6 wherein the step of including a location for the assist feature comprises:
assigning a coordinate to each of the examined respective areas; and
locating the assist feature at a location that is an average of the coordinates assigned to the examined respective areas.

10. The method of claim 6 wherein the step of including a location for the assist feature in an overlap of the respective areas comprises:
identifying a shape that encompasses all ones of the examined respective areas; and
locating the assist feature at a location that is at a center of the shape.

11. The method of claim 1 wherein the step of indicating parameters for forming a second plurality of assist features on the reticle comprises:
examining an area adjacent to and extending away from each edge of a primary feature in the plurality of primary features; and
including parameters for forming an assist feature at least in part in the area if less than a threshold amount of assist feature is to be formed in each respective edge area per the parameters for forming the first plurality of assist features.

12. The method of claim 1 wherein the step of indicating parameters for forming a second plurality of assist features on the reticle comprises:
for a first and second primary feature in the plurality of primary features, examining a respective area adjacent to and extending away from an edge of each of the first and second primary features; and
including parameters for forming an assist feature at least in part in at least one of the respective areas if less than a threshold amount of assist feature is to be formed in at least one of the respective areas.

13. The method of claim 12 wherein the step of including parameters for forming an assist feature in the second plurality of assist features is conditioned on the assist feature in the second plurality of assist features not printing a corresponding feature on the semiconductor wafer when the reticle is used in projecting the image to the semiconductor wafer.

14. The method of claim 12:
wherein the step of including parameters for forming an assist feature in the second plurality of assist features comprises including parameters for forming a rectangular assist feature if an imaginary line perpendicularly extended from the edge of the first primary feature would contact, in substantial perpendicular orientation, an edge of the second primary feature; and
wherein the rectangular assist feature comprises a majority axis parallel to the edges of the first and second primary features.

15. The method of claim 14 wherein the step of including parameters for forming a rectangular assist feature comprises including parameters so that the majority axis is centered between the edges of the first and second primary features.

16. The method of claim 14 wherein the step of including parameters for forming an assist feature in the second plurality of assist features is conditioned on the assist feature in the second plurality of assist features not printing a corresponding feature on the semiconductor wafer when the reticle is used in projecting the image to the semiconductor wafer.

17. The method of claim 12 wherein the respective area adjacent to and extending away from an edge of each of the first and second primary feature comprises a same dimensioned area.

18. The method of claim 12 wherein the step of including parameters for forming an assist feature at least in part in the area if less than a threshold amount of assist feature is to be formed comprises including a location for the assist feature at least in part in an overlap of the respective areas.

19. The method of claim 18 wherein the step of including a location for the assist feature comprises locating the assist feature at a location that is an average of respective locations of the selected ones of the assist features that, prior to the step of selectively removing, had locations in the examined respective areas.

20. The method of claim 18 wherein the step of including a location for the assist feature comprises locating the assist feature at a location that is a center-of-mass of the examined respective areas.

21. The method of claim 18 wherein the step of including a location for the assist feature comprises:
assigning a coordinate to each of the examined respective areas; and
locating the assist feature at a location that is an average of the coordinates assigned to the examined respective areas.

22. The method of claim 18 wherein the step of including a location for the assist feature comprises:
identifying a shape that encompasses the examined respective areas; and
locating the assist feature at a location that is at a center of the shape.

23. The method of claim 12:
wherein the step of including parameters for forming an assist feature in the second plurality of assist features comprises including parameters for forming a two-portion assist feature if an imaginary line perpendicularly extended from the edge of the first primary feature would contact, in substantially perpendicular orientation, an imaginary line perpendicularly extended from the edge of the second primary feature; and
wherein the two-portion feature comprises a first portion parallel to the edge of the first primary feature and a second portion parallel to the edge of the second primary feature.

24. The method of claim 23 wherein the step of including parameters for forming an assist feature in the second plurality of assist features is conditioned on the assist feature in the second plurality of assist features not printing a corresponding feature on the semiconductor wafer when the reticle is used in projecting the image to the semiconductor wafer.

25. The method of claim 1 wherein the step of indicating parameters for forming a second plurality of assist features on the reticle comprises:
for three or more primary features in the plurality of primary features, examining a respective area adjacent to and extending away from an edge of each of the three or more primary features; and
including parameters for forming an assist feature at least in part in at least one of the respective areas if less than a threshold amount of assist feature is to be formed in at least one of the respective areas, per the parameters for forming the first plurality of assist features.

26. The method of claim 25 wherein the step of including parameters for forming an assist feature in the second plurality of assist features is conditioned on the assist feature in the second plurality of assist features not printing a corresponding feature on the semiconductor wafer when the reticle is used in projecting the image to the semiconductor wafer.

27. The method of claim 26 wherein the step of including parameters for forming an assist feature in the second plurality of assist features comprises including parameters for forming a square assist feature.

28. The method of claim 25 wherein the respective area adjacent to and extending away from an edge of each of the three or more primary feature comprises a same dimensioned polygon area.

29. The method of claim 1 wherein the step of indicating parameters for forming a second plurality of assist features on the reticle comprises indicating parameters such that at least one assist feature in the second plurality of assist features is smaller than a smallest feature in the first plurality of assist features.

30. The method of claim 1 and further comprising, following the second iteration, selectively removing the parameters of selected ones of the assist features in the second plurality of assist features so that removed parameters are not used in forming reticle features.

31. A method of operating a computing system to determine reticle data, the reticle data for completing a reticle for use in projecting an image to a semiconductor wafer, the method comprising:
first, receiving circuit design layer data comprising a desired circuit layer layout, the layout comprising a plurality of circuit features; and
second, providing the reticle data for inclusion in an output data file for use in forming reticle features on the reticle, the providing step comprising:
indicating parameters for forming a plurality of primary features on the reticle, the primary features of the plurality of primary features corresponding to the plurality of circuit features; and
indicating parameters for forming a first plurality of assist features on the reticle, wherein in use of the reticle for use in projecting the image to the semiconductor wafer the first plurality of assist features, if formed on the reticle, are for assisting corresponding ones of the primary features; and
selectively removing the parameters of selected ones of the assist features in the first plurality of assist features so that removed parameters are not used in forming reticle features; and
third, indicating parameters for forming a second plurality of assist features on the reticle, wherein in use of the reticle for use in projecting the image to the semiconductor wafer the second plurality of assist features, if formed on the reticle, are for assisting corresponding ones of the primary features.

32. The method of claim 31 wherein the step of indicating parameters for forming a second plurality of assist features on the reticle comprises:
examining an area adjacent to and extending away from a respective edge of a primary feature in the plurality of primary features; and
including parameters for forming an assist feature at least in part in the area if less than a threshold amount of assist feature is to be formed in the area per the parameters for forming the first plurality of assist features.

33. The method of claim 31 wherein the step of indicating parameters for forming a second plurality of assist features on the reticle comprises:
examining a respective area adjacent to and extending away from a respective edge of two or more respective primary features in the plurality of primary features; and
including parameters for forming an assist feature in an overlap of the respective areas if less than a threshold amount of assist feature is to be formed in at least one of the respective areas.

34. A computer readable medium encoded with a computer readable computer program and for causing a computing system to perform the steps of:
receiving circuit design layer data comprising a desired circuit layer layout, the layout comprising a plurality of circuit features; and
providing the reticle data for inclusion in an output data file for use in forming reticle features on the reticle, the providing step comprising:
in a first iteration:
indicating parameters for forming a plurality of primary features on the reticle, the primary features of the plurality of primary features corresponding to the plurality of circuit features; and
indicating parameters for forming a first plurality of assist features on the reticle, wherein in use of the reticle for use in projecting the image to the semiconductor wafer the first plurality of assist features, if formed on the reticle, are for assisting corresponding ones of the primary features; and
selectively removing the parameters of selected ones of the assist features in the first plurality of assist features so that removed parameters are not used in forming reticle features; and
in a second iteration, indicating parameters for forming a second plurality of assist features on the reticle, wherein in use of the reticle for use in projecting the image to the semiconductor wafer the second plurality of assist features, if formed on the reticle, are for assisting corresponding ones of the primary features.

35. The medium of claim 34 wherein the step of indicating parameters for forming a second plurality of assist features on the reticle comprises:
examining an area adjacent to and extending away from an edge of a primary feature in the plurality of primary features; and
including parameters for forming an assist feature at least in part in the area if less than a threshold amount of assist feature is to be formed in the area per the parameters for forming the first plurality of assist features.
